(19) United States
(12) Patent Application Publication
(10) Pub. No.: US 2005/0265650 A1
(43) Pub. Date: Dec. 1, 2005

(54) Small profile, pluggable optical transceiver subassembly

(76) Inventors: Sunil Priyadarshi, Simi Valley, CA (US); Jesse Whitaker Booker, Danbury, CT (US); Kishore K. Kamath, Sunnyvale, CA (US); Ihab E. Khalouf, Allentown, PA (US); Shaun Scrak, Macungie, PA (US)

Correspondence Address: Wendy W. Koba, PO Box 556, Springtown, PA, 18081, US

(21) Appl. No.: 10/855,093

(22) Filed: May 27, 2004

(51) Int. Cl. G02B 6/36

(52) U.S. Cl. 385/14; 385/89

(57) ABSTRACT

A relatively small, pluggable optical transceiver utilizes a set of at least three separate printed wiring boards (PWBs), coupled together with a pair of flexible wiring boards, allows for the “middle” (base) PWB to be disposed in a horizontal plane, with the PWBs on either side (i.e., a transmitter PWB and a receiver PWB) to be disposed parallel to the base PWB, by virtue of using the flexible PWBs. Advantageously, the optoelectronic transmitter and receiver modules are directly connected (hardwired) to their respective, vertical PWBs, to form a rugged arrangement. Crosstalk between the vertical boards is reduced by using a shielding plate between the boards. Undesired fiber movement is reduced (as compared to the prior art) by separating the optical path from the electrical path, which also provides mechanical relief for the transmitter and receiver PWBs.

### TECHNICAL FIELD

The present invention relates to an optical transceiver subassembly and, more particularly, to the use of flex connections between a pair of vertically disposed transmitter and receiver circuit boards and a base circuit board to reduce the size of the overall subassembly, while also reducing crosstalk and improving the optical/electrical connection in the subassembly.

### BACKGROUND OF THE INVENTION

While significant progress has been made in the field of fiber optics, more widespread use is dependent on the availability of a low cost and efficient optical transmitter and receiver module to link fiber optics to various electronic devices and components such as computers and routers. A critical aspect of such a module is the accurate alignment and attachment of the individual optical fibers to the electronic devices that transmit and receive light streams to and from the optical fibers. These electronic devices, known as optoelectronic devices, convert electrical signals into optical radiation and transmit the radiation into optical fibers. Other optoelectronic devices receive optical radiation from optical fibers and convert it into electrical signals for processing.

The state of the art has developed to provide what is defined as an “optical transceiver subassembly”, which includes the optoelectronic devices (i.e., laser and photodiode) and optical connectors for mating with a pair of optical fibers, and a printed wiring board (PWB) for providing the electronic transmitter and receiver components, with electrical connections between the PWB and the optoelectronic devices. In order to increase the efficiency and utilization of an optical transceiver subassembly, it is desired that the subassembly be “pluggable” into a module housing various other components/elements used in a larger communication system, thus requiring that certain overall physical limitations be adhered to, as well as the electrical pin-out from the transceiver matching the electrical contacts on the module.

Pluggable optical transceivers have been the subject of various industry standards and sourcing agreements between common vendors. In particular, a number of vendors have entered into a multi-source agreement (MSA), setting forth common standards and specifications for small form factor pluggable (SFP) tranceivers. The pluggable transceiver includes a first end with a fiber connector and a second, opposing end with an electrical connector. The electrical connector is defined as a PWB card edge connector, which is then being received into a female electrical connector housed inside a receptacle. The receptacle assembly is mounted on a daughter card of a host system. A common mechanical and electrical outline for the SFP transceiver is defined by the MSA. However, each individual manufacturer (vendor) is responsible for its own development and manufacturing of the SFP transceiver including developing an arrangement for interconnecting the electronic printed wiring board (or boards) to the optoelectronic devices.

In some pluggable transceiver arrangements, a single circuit board containing transmitter and receiver circuits is used, with separate connections to the optical transmitter and receiver devices. One problem with this arrangement is the presence of electrical crosstalk, deteriorating the signal quality. Many arrangements have thus been proposed that utilize a pair of vertically disposed circuit boards, one board for the transmitter electronics and a separate board for the receiver electronics. U.S. Pat. No. 6,213,651 issued on Apr. 10, 2001 to Jiang et al. discloses one such arrangement. In the Jiang et al. arrangement, the pair of vertical circuit boards is mated with slots formed in a horizontal support board, with a plurality of contact pins on each vertical board then mated with an associated set of pin holes on the horizontal board. The required edge connector is then formed on the horizontal support board.

The formation of these slots and pin holes needs to be well-controlled to provide the required stability in the overall arrangement. Indeed, over time, the stability of this type of rigid interconnection may become problematic. Moreover, the issue of electrical crosstalk between the vertical boards needs to be addressed. U.S. Pat. No. 6,661,565 issued on Dec. 9, 2003 to C-D Shaw et al. addresses the crosstalk problem by proposing an arrangement that utilizes perpendicularly disposed boards (i.e., the “back” of the vertical board is positioned against the edge of the horizontal board), thus preventing crosstalk while also eliminating the need for electromagnetic interference (EMI) shielding. Problems remain with these and other arrangements, however, in terms of providing a robust connection between the optical devices and their associated circuit boards, the connections requiring an orthogonal connection be made between the optoelectronic devices and the circuit boards.

One proposed solution to the connection problem is to use a flexible PWB connection between the optical and electronic assemblies. U.S. Pat. No. 6,659,656 issued on Dec. 9, 2003 to J. R. Brezina et al. discloses one such arrangement, with a flexible circuit board used to provide a connection between a pair of horizontal electronic circuit boards and vertical optoelectronic devices.

A remaining problem with all of the prior art arrangements is the physical separation between the optical and electrical components, which is thought as necessary to meet the requirements of the MSA, yet leads to signal distortion between the components.

### SUMMARY OF THE INVENTION

The need remaining in the prior art is addressed by the present invention, which relates to an optical transceiver subassembly and, more particularly, to the use of flex connections between the vertical transmitter/receiver circuit boards and a base circuit board to reduce the size of the overall subassembly, while also reducing crosstalk and improving the optical/electrical connections within the subassembly.

In accordance with the present invention, a fixed connection is made between the optoelectronic transmitting module and its associated electrical circuit board, the board being disposed in the vertical plane of the packaged subassembly. Similarly, a fixed connection is made between the optoelectronic receiving module and its associated electrical circuit board. A pair of flex connectors is then used to interconnect the vertical transmitter and receiver circuit boards with a base circuit board, the base board including the edge connector required to carry the signal paths for interconnection to a host board. The use of flex connections is seen to overcome the prior art problems associated with a rigid connection between the vertical boards and the horizontal host board. In this arrangement, therefore, the optical signal path is associated only with the vertical transmitter and receiver boards, and the electrical input/output signals are coupled only to the horizontal host board.

In an alternative embodiment of the present invention, an additional flexible PWB and rigid PWB combination may be added to the above-described arrangement, providing the ability to supplement the electronic circuitry that may be included within the small form factor pluggable optical transceiver. In particular, the additional flexible PWB is connected to either the transmitter or receiver PWB (in opposition to the location of the first flexible PWB), with the additional rigid PWB then connected to the flexible PWB. The additional flexible PWB is then “bent” to fold the additional rigid PWB over the top of the vertically disposed boards, so as to be parallel with the base PWB.

Other and further advantages and aspects of the present invention will become apparent during the course of the following discussion and by reference to the accompanying drawings.

### BRIEF DESCRIPTION OF THE DRAWINGS

Referring now to the drawings, in which like reference numerals refer to similar elements:

FIG. 1 illustrates an exemplary circuit board arrangement, in its “unfolded” form, that may be used in the optical transceiver subassembly of the present invention;

FIG. 2 illustrates the circuit board arrangement of FIG. 1, with the associated optoelectronic modules coupled to the transmitter and receiver circuit boards;

FIG. 3 contains an isometric view of the arrangement of FIG. 2, with the transmitter and receiver circuit boards “folded” into their vertical positions, as used within the subassembly package of the present invention;

FIG. 4 is an exploded view of the subassembly package of the present invention, illustrating the outer housing component, the folded board arrangement of FIG. 3, and an optical connector receptacle;

FIG. 5 illustrates an alternative arrangement of the flex-connected circuit boards of the present invention, where an additional flexible PBW and rigid PWB are connected to the receiver circuit board, so as to form a three-dimensional folded arrangement;

FIG. 6 illustrates the arrangement of FIG. 5, further showing the optoelectronic transmitter and receiver modules electrically connected to the transmitter and receiver PWBs;

FIG. 7 contains a view of the arrangement of FIG. 6, with the transmitter and receiver PWBs “folded” into a vertical position with respect to the base (horizontal) PWB; and

FIG. 8 is an exploded view of a subassembly package of this alternative embodiment of the present invention, illustrating an outer housing component, the folded board arrangement of FIG. 7, and an optical connector receptacle.

### DETAILED DESCRIPTION

FIG. 1 illustrates an exemplary circuit board arrangement 10, formed in accordance with the present invention, that may be used to form the transmitter and receiver electrical circuits of the present invention. As shown, arrangement 10 comprises a first rigid printed wiring board (PWB) 12 used to support the transmitter electronic components and signal paths, and a second rigid PWB 14 used to support the receiver electronic components and signal paths. A third (“base”) PWB 16, disposed between first PWB 12 and second PWB 14, is electrically connected to boards 12 and 14 via a pair of flexible PWBs 18 and 20, respectively. In accordance with the “pluggable” aspect of the arrangement of the present invention, base PWB 16 includes a rear edge connector 22 that has the proper leads for interconnection with a host board (not shown).

FIG. 2 illustrates a further construct of the present invention, where a transmitter optical assembly 24 and a receiver optical assembly 26 are connected to first and second PWBs 12 and 14, respectively. Transmitter assembly 24 comprises a module 28 housing the electrical elements required to drive an optical transmitting device (such as a laser or LED), as well as the optical device itself. Coupled to, and in optical alignment with, the housed optical device is as optical connector portion 30, which is attached to module 28. An optical fiber (not shown) will thereafter be disposed within connector 30 to allow for transmission of the transmitted optical output signal. Advantageously, separating the optical and electrical signal paths has been found to reduce the amount of unwanted fiber movement. The internal components of module 28, as well as the particular coupling arrangement between module 28 and connector portion 30 are not germane to the subject matter of the present invention.

The important aspect of transmitter optical assembly 24 is the use of a set of relatively short electrical leads 32 to provide the electrical connection between optical assembly 24 and transmitter PWB 12. As mentioned above, some prior art arrangements utilize a flexible PWB to provide this connection, particularly in situations where the connection is required to make a 90° turn. In contrast, the arrangement of the present invention allows for a fixed, short set of leads to be used for this connection. Advantageously, the mechanical stability of this arrangement is improved over that of the prior art, while also using relatively short leads (allowing for higher transmission data rates to be employed). In a similar fashion, receiver optical assembly 26 includes a receiver module 34 housing the necessary electronics and optics, and an optical connector 36 for ultimate connection to an incoming optical fiber (not shown). A set of leads 38 is used to electrically couple receiver module 34 to receiver PWB 14.

In accordance with the teaching of the present invention, the use of flexible PWBs 18 and 20 allows for transmitter PWB 12 and receiver PWB 14 to be rotated from a horizontal position into a vertical position with respect to base PWB 16, as indicated by the arrows in FIG. 2. FIG. 3 illustrates the arrangement of the present invention subsequent to the rotation of PWBs 12 and 14 into the vertical position. As an improvement over the prior art arrangements using vertical circuit boards, the arrangement of the present invention does not require slots to be formed in base rigid PWB 16, nor is there a need to form fixed, rigid pins and associated pin holes to provide electrical connections between the boards. The flexible PWBs 18 and 20 of the present invention provide all necessary electrical connections between the various boards.

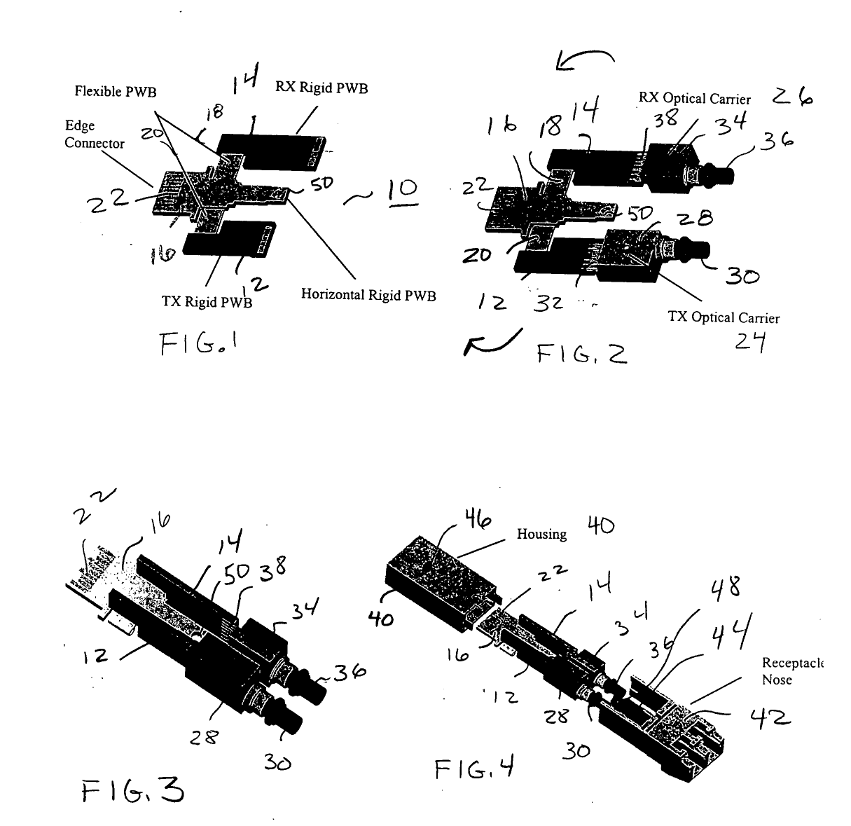

As mentioned above, there is a need to minimize the presence of crosstalk in an arrangement using vertical circuit boards. FIG. 4 illustrates, in an exploded view, additional components of an exemplary embodiment of the present invention, particularly illustrating a housing 40 for enclosing the entire arrangement and an optical receptacle 42 for mating with optical fibers (not shown), where in this case optical receptacle 42 is formed to include an internal grounding plane 44. Referring to FIG. 4, grounding plane 44 is disposed within optical receptacle 42 so as to be positioned between transmitter PWB 12 and receiver PWB 14, thus minimizing the presence of crosstalk between these boards. EMI shielding is provided by electrically connecting grounding plane 44 to a chassis ground (at any desired location) or a circuit power ground. As a further advantage of the arrangement of the present invention, a set of through-holes 46, 48 and 50 can be formed in an aligned arrangement in housing 40, grounding plane 44 and base PWB 16 (see, for example, FIGS. 1-3, for a view of through-hole 50 in base PWB 16), where these three components can then be screwed/pinned together in the aligned through-hole arrangement to provide mechanical stability to the final subassembly structure.

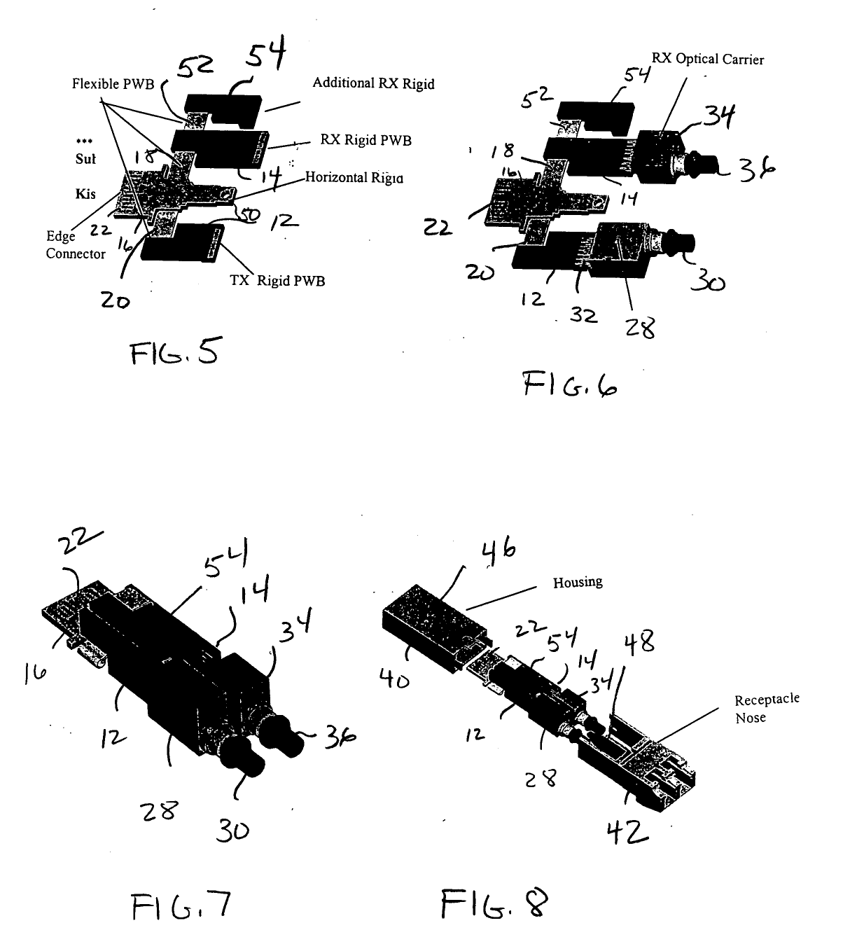

FIGS. 5-8 illustrate an alternative embodiment of the present invention, where another flexible PWB and rigid PWB are added to the arrangement as described above. Advantageously, the use of another flexible PWB/rigid PWB set allows for additional circuitry to be added to the subassembly, particularly useful when the receiver circuitry requires additional components and the arrangement is limited by physical dimensions (as in the case for the multi-vendor MSA and the SFP transceiver). Referring to FIG. 5, the arrangement as discussed above has been supplemented with another flexible PWB 52, coupled to receiver PWB 14 and disposed in opposition to flexible PWB 18. Connected to flexible PWB 52 is an additional receiver PWB 54. It is to be understood that instead of adding more circuitry to the receiver portion of the transceiver arrangement, a flexible PWB and associated rigid PWB may be coupled to transmitter PWB 12. FIG. 6 illustrates this alternative embodiment incorporating an additional receiver PWB 54, subsequent to the attachment of transmitter module 24 and receiver module 26. As with the arrangement described above, these modules are directly connected (through short electrical leads 32 and 38) to transmitter PWB 12 and receiver PWB 14, respectively.

FIG. 7 illustrates the “folded” positioning of the various PWBs (flexible and rigid) in this alternative embodiment of the present invention. As before, transmitter PWB 12 and receiver PWB 14 are rotated so as to be disposed in the vertical direction (with respect to horizontally disposed base PWB 16). In this particular embodiment of the present invention, flexible PWB 52 is then bent so as to allow additional receiver PWB 54 to be folded over, as shown in FIG. 7, and form a “top” PWB in the structure, essentially parallel to base PWB 16. Thus, while still restricted to the physical limitations of the agreed-upon MSA for optical transceivers, the arrangement of the present invention provides additional surface area for the formation of necessary electronic circuitry. FIG. 8 is an exploded view of this alternative embodiment, illustrating the positioning of housing 40 and optical receptacle 42 with respect to the other components discussed above, particularly illustrating the ability to still include grounding plane 44 as positioned between transmitter PWB 12 and receiver PWB 14.

One advantage of the arrangement of the present invention is the ability to change out either (or both) of the optical transmitter and optical receiver devices, as needed, as a result of the increased availability of space for additionally required components. For example, the arrangement of the present invention may be used with an avalanche photodiode (APD) as the optical receiving device, where the APD is known as requiring DC-to-DC converting circuitry to provide the higher voltage required to bias the APD. The utilization of both vertical boards and a horizontal host board allows for the addition of more circuitry, such as a thermoelectric cooler (TEC), which is important in situations where laser cooling is required. One such situation, for example, is a small form-factor DWDM pluggable transceiver arrangement, where the laser in this arrangement requires cooling. Other components that may be located on the host board include elements such as, for example, TEC driver circuitry, a micro-controller, power supply filters, etc.

The use of vertical circuit boards with the flex connection to the main horizontal board in accordance with the present invention allows for the electronics required to power and drive the optical modules (i.e., transmitter and receiver) to be incorporated into the design of the vertical boards, allowing for these elements to be placed relatively close to the optical modules themselves. Indeed, the ability to minimize this separation allows for the high frequency operation of the transceiver to be optimized. Additionally, the use of vertical circuit boards allows for both sides of the boards to be populated with necessary components. Undesired fiber movements are also minimized by separating the optical and electrical signal paths onto separate boards.

Another advantage of the arrangement of the present invention is the ability to utilize optoelectronic components of different physical sizes (for example, different optical transmitter and receiver modules), since the optoelectronic components are attached by way of fixed, relatively short electric connections to their associated vertical boards, with no need for additional mechanical relief. The use of relatively short connections further improves the ability of the transceiver to operate at high speeds, as compared to the use of flexible connections between the optical and electrical modules.

It is to be understood that various changes and modifications may be made to the above-described embodiments of the present invention, as will be apparent to those skilled in the art. Such changes and modifications may be made without departing from the spirit and scope of the present invention, and without diminishing its attendant advantages. It is, therefore, intended that such changes and modifications fall within the spirit and scope of the present invention as defined by the claims appended hereto.

1. An optical transceiver subassembly comprising
a transmitter printed wiring board (PWB) supporting a plurality of electronic components associated with transmission of an optical signal;
an optoelectronic transmitter module coupled with the transmitter PWB for converting electrical signals present at the output of the transmitter PWB into an output optical data signal, the optoelectronic transmitter module including an optical connector for coupling to an optical fiber;
a receiver printed wiring board (PWB) for supporting a plurality of electronic components associated with the reception of an optical signal;
an optoelectronic receiver module coupled with the receiver PWB for converting a received optical signal into an electronic representation thereof, the optoelectronic receiver module including an optical connector for coupling to an optical fiber;
a base PWB for providing electrical data signal connections and electrical power connections to the transmitter and receiver PWBs;
a first flexible PWB connected between the base PWB and the transmitter PWB; and
a second flexible PWB connected between the base PWB and the receiver PWB.

2. An optical transceiver as defined in claim 1 wherein the transmitter PWB includes active and passive electronic components to drive the optoelectronic transmitter module.

3. An optical transceiver as defined in claim 1 wherein the receiver PWB includes active and passive electronic components to drive the optoelectronic receiver module.

4. An optical transceiver subassembly as defined in claim 1 wherein the first and second flexible wiring boards are disposed such that the transmitter PWB and the receiver PWB are disposed in a vertical plane with respect to a horizontally-disposed base PWB.

5. An optical transceiver subassembly as defined in claim 4 wherein the subassembly further comprises a metallic shielding plate disposed between the vertically-disposed transmitter PWB and the vertically-disposed receiver PWB, the metallic shielding plate connected to a ground plane to reduce crosstalk between said transmitter and receiver PWBs.

6. An optical transceiver subassembly as defined in claim 5 wherein the metallic shielding plate is connected to a chassis ground.

7. An optical transceiver subassembly as defined in claim 5 wherein the metallic shielding plate is connected to a circuit power ground connection.

8. An optical transceiver subassembly as defined in claim 5 wherein the subassembly further comprises a metallic optical connector receptacle for mating with the optical connectors of the transmitter and receiver optoelectronic modules, the metallic shielding plate formed as a central partition component of said metallic optical connector receptacle.

9. An optical transceiver subassembly as defined in claim 1 wherein the base PWB further comprises an edge connector for connecting the optical transceiver subassembly to additional communication components.

10. An optical transceiver subassembly as defined in claim 1 wherein the subassembly further comprises an additional flexible PWB and an additional rigid PWB, the additional flexible PWB attached to one of the transmitter and receiver PWBs, said additional flexible PWB positioned in opposition to one of the first and second flexible PWBs, and said additional rigid PWB coupled to said additional flexible PWB.

11. An optical transceiver subassembly as defined in claim 10 wherein the additional flexible PWB is folded in a manner such that the additional rigid PWB is disposed to as to be essentially parallel to the base PWB.

12. An optical transceiver subassembly as defined in claim 10 wherein the additional flexible PWB is attached to the receiver PWB and the additional rigid PWB comprises a second receiver PWB.

13. An optical transceiver subassembly as defined in claim 10 wherein the additional flexible PWB is attached to the transmitter PWB and the additional rigid PWB comprises a second transmitter PWB.

14. An optical transceiver subassembly comprising:
a rigid transmitter printed wiring board (PWB) including electrical components for transmission of an optical signal;
a rigid receiver PWB including electrical components for receiving an incoming optical signal;
a rigid base PWB to provide electrical data signal connections and electrical power connections to the transmitter PWB and the receiver PWB;
a first flexible PWB to couple the base PWB with the transmitter PWB; and
a second flexible PWB to couple the base PWB with the receiver PWB.

15. The optical transceiver subassembly of claim 14, wherein the base PWB is horizontally oriented, and the first and second flexible wiring boards are disposed such that the transmitter PWB and the receiver PWB are vertically oriented relative to the base PWB.

16. The optical transceiver subassembly of claim 15, further comprising a metallic shielding plate disposed between the vertically-oriented transmitter PWB and the vertically-oriented receiver PWB, the metallic shielding plate coupled with a ground plane to reduce crosstalk between the transmitter and receiver PWBs

17. The optical transceiver subassembly of claim 16, wherein the metallic shielding plate is coupled with a chassis ground.

18. The optical transceiver subassembly of claim 16, wherein the metallic shielding plate is coupled with a circuit power ground connection.

19. The optical transceiver subassembly of claim 14, wherein the base PWB further comprises an edge connector to couple the optical transceiver subassembly with additional communication components.

20. The optical transceiver subassembly of claim 14, further comprising:
an additional flexible PWB connected on a first side to a first edge of the rigid transmitter or receiver PWB, wherein a second edge of the rigid transmitter or receiver PWB opposite the first edge is connected to the first or second flexible PWB; and
an additional rigid PWB connected with a second side of the additional flexible PWB, wherein the second side is opposite the first side.

21. The optical transceiver subassembly of claim 14, further comprising:
an optoelectronic transmitter module coupled with the transmitter PWB, to convert electrical signals received from the transmitter PWB into an output optical signal, the optoelectronic transmitter module including a transmitter optical connector for coupling with an optical fiber that receives the output optical signal; and
an optoelectronic receiver module coupled with the receiver PWB, to convert the incoming optical signal into an electronic signal to be input to the receiver PWB, the optoelectronic receiver module including an receiver optical connector for coupling with an optical fiber that carries the incoming optical signal.

22. The optical transceiver subassembly of claim 21, wherein the transmitter PWB includes active and passive electronic components to drive the optoelectronic transmitter module.

23. The optical transceiver subassembly of claim 21, wherein the receiver PWB includes active and passive electronic components to drive the optoelectronic receiver module.

24. The optical transceiver subassembly of claim 21, wherein the base PWB is horizontally oriented, and the first and second flexible wiring boards are disposed such that the transmitter PWB and the receiver PWB are vertically oriented relative to the base PWB.

25. The optical transceiver subassembly of claim 24, further comprising a metallic shielding plate disposed between the vertically-oriented transmitter PWB and the vertically-oriented receiver PWB, the metallic shielding plate coupled with a ground plane to reduce crosstalk between the transmitter and receiver PWBs.

26. The optical transceiver subassembly of claim 12, further comprising a metallic optical connector receptacle to couple the optical transceiver subassembly with optical connections of the transmitter and receiver optoelectronic modules, the metallic shielding plate formed as a central partition within the metallic optical connector receptacle.
